(19) United States
(12) Patent Application Publication
(10) Pub. No.: US 2008/0218483 A1
(43) Pub. Date: Sep. 11, 2008

(54) APPARATUS AND METHOD FOR A CONVERGED KEYBOARD AND REMOTE CONTROL DEVICE

(76) Inventor: Matthew I. Royer, Dupont, WA (US)

Correspondence Address: INTEL CORPORATION;c/o INTELLEVATE, LLC, P.O. BOX 52050, MINNEAPOLIS, MN, 55402, US

(21) Appl. No.: 11/682,671

(22) Filed: Mar. 6, 2007

(51) Int. Cl. G06F 3/02

(52) U.S. Cl. 345/169

(57) ABSTRACT

Apparatus and method for a converged remote control and keyboard device. An embodiment of an apparatus comprises a remote control, a keyboard and a processor to receive a control signal to determine whether to enable functionality of the remote control or functionality of the keyboard. Other embodiments are described and claimed.

### BACKGROUND

The importance for the consumer electronic device industry to continuously strive to produce products that are easy to use cannot be overstated. No doubt this is one of the reasons for the introduction of the home entertainment center and the remote control, to name a few. For example, today's homes may have one or more electronic devices, such as personal computers (PCs), televisions, digital video disk (DVD) players, video cassette recorder (VCR) players, compact disk (CD) players, set-top boxes, stereo receivers, audio/video receivers (AVRs), media centers, personal video recorders (PVRs), gaming devices, digital camcorders, digital cameras, and so forth, all connected together in such a way to provide a user with a means for entertainment via the home entertainment center and a single display device.

As the number of devices in the home entertainment center continues to grow, so does the complexity and frustration for the user to easily interface with all of the devices in the typical home entertainment manner that he or she may be accustomed. For example, a typical remote control might suffice to interface with such devices as a television, a DVD player, and so forth, but cannot be easily used to interface with a PC for instant messaging, electronic mail, web surfing, etc.

### BRIEF DESCRIPTION OF THE DRAWINGS

FIG. 1 illustrates one embodiment of a converged remote control and keyboard device.

FIG. 2 illustrates one embodiment of a converged remote control and keyboard device.

FIG. 3 illustrates one embodiment of a system.

FIG. 4 illustrates one embodiment of a logic flow.

### DETAILED DESCRIPTION

Various embodiments may be generally directed to a converged keyboard and remote control device. The converged device provides for a form factor that easily adapts between two types of interface devices. The one type of interface device is a remote control that allows for easy or typical interaction with home entertainment devices, such as a television, a DVD player, VCR player, and so forth. The other type of interface device is a keyboard, such as a micro QWERTY keyboard, that allows for easy or typical interaction with a PC and other similar devices. In an embodiment, the remote control functionality of the converged device is enabled when the lid of the converged device is closed. The keyboard functionality of the converged device is enabled when the lid of the converged device is open. Other embodiments may be described and claimed.

Various embodiments may comprise one or more elements or components. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

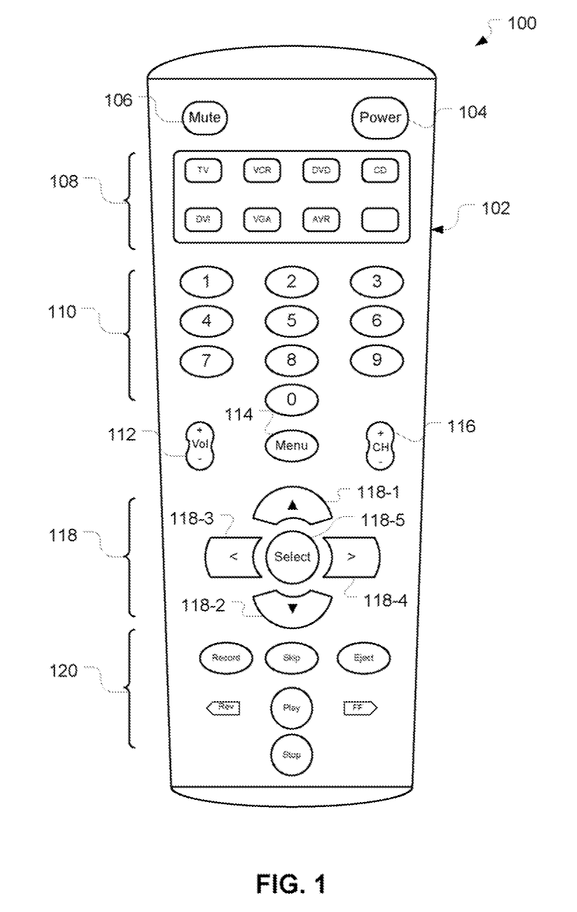

FIG. 1 illustrates one embodiment of a converged remote control and keyboard device 100. As mentioned above, converged device 100 provides for a form factor that easily adapts between two types of interface devices, a remote control and a keyboard. Referring to FIG. 1, a remote control 102 of converged device 100 is illustrated. In an embodiment, remote control functionality is enabled when the lid of the converged device is closed, as illustrated in FIG. 1. A processor (not shown in FIG. 1) may be used to determine, via a control signal, which type of functionality to enable.

In an embodiment, remote control 102 operates as a conventional remote control unite used to interact with audio/visual devices such as media centers, televisions, monitors, cable boxes, DVD players, CD players, DVRs, video games, digital video cameras, and/or digital still cameras, among others, for example. Remote control 102 may comprise a power button 104, a mute button 106, electronic device buttons 108, numerical buttons 110, a volume up and down button 112, a menu button 114, a channel up and down button 116, navigation buttons 118 and video play buttons 120. In one embodiment, navigation buttons 118 comprise an upward navigation button 118-1, a downward navigation button 118-2, a leftward navigation button 118-3, and a rightward navigation button 118-4. Navigation buttons 118 also may comprise a select button 118-5 to execute a particular function. The example embodiment of remote control 102 shown in FIG. 1 is provided for illustration purposes only and is not meant to limit the invention.

Remote control 102 of converted device 110 may be implemented as a wireless remote that operates on wireless principles employing infra-red (IR) energy or radio frequency (RF) energy. In other embodiments, remote control 102 may be hard wired to the display device, for example. In fact, remote control 102 may be any combination of computer hardware and/or software components (specifically human interface device) that allows a user to input spatial (i.e., continuous and multi-dimensional) data into one or more devices. The embodiments, however, are not limited to the element or in the context shown or described in FIG. 1.

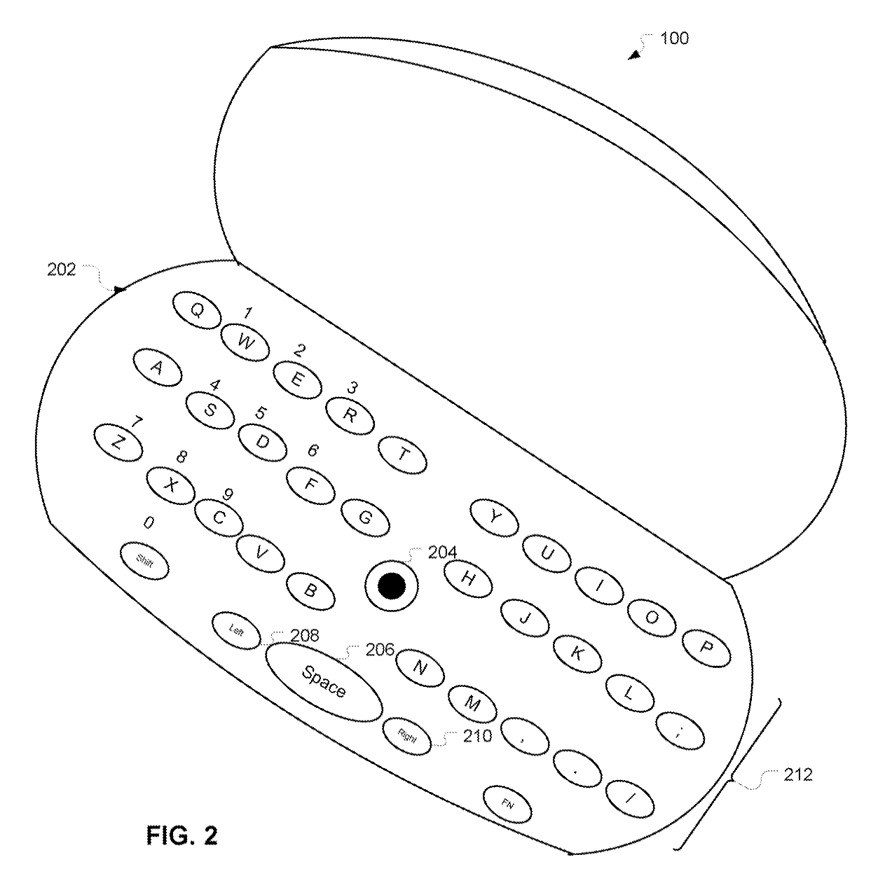

Referring to FIG. 2, a keyboard 202 of converged device 100 is illustrated. In an embodiment, keyboard functionality is enabled when the lid of converged device 100 is opened, as illustrated in FIG. 2. In an embodiment, keyboard 202 operates as a conventional keyboard used to interact with a PC or other such devices where the interaction via a keyboard interface is easy and typical.

Referring to FIG. 2, keyboard 202 may be comprised, but is not necessarily limited to, a thumb mouse 204, a space key 206, a left mouse click key 208, a right mouse click key 210 and alphanumeric keys 212. In an embodiment, the key layout of keyboard 202 may be similar to that of a micro QWERTY keyboard used, for example, with pocket PCs, smart phones, and so forth. In another embodiment, the key layout of keyboard 202 may be similar to that of a DVORAK keyboard. The keys of keyboard 202 may be customized via the remapping of the keys by a user. Keyboard 202 may also include other types of input including a touch pad, input buttons, switches, rocker switches, voice recognition functionality, and so forth. The example embodiments are not meant to limit the invention.

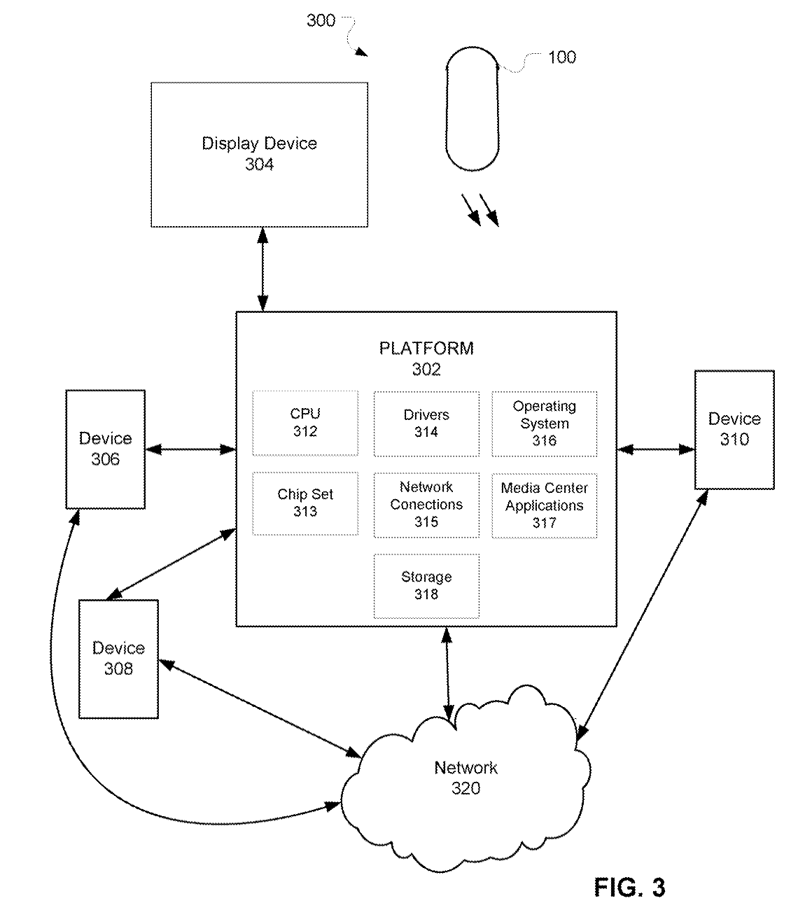

FIG. 3 illustrates one embodiment of a system 300 in which converged remote control and keyboard device 100 may operates. In one embodiment, system 300 may be a digital home entertainment system, although system 300 is not limited in this context. In one embodiment, system 300 comprises a platform 302 coupled to a display device 304. Platform 302 may be coupled to one or more devices 306, 308 and 310. Although only three devices are shown in FIG. 3, there may be any number of devices coupled to platform 302. Platform 302 may also be coupled to a network 320. Each of these components is described next in more detail.

In one embodiment, platform 302 may comprise or may be implemented as a media platform such as the Viiv™ media platform made by Intel® Corporation. In one embodiment, platform 302 may receive content directly from one or more devices 306, 308 and 310 and/or via network 320.

In one embodiment, platform 302 may comprise a CPU 312, a chip set 513, one or more drivers 314, one or more network connections 315, an operating system 316, and/or one or more media center applications 317 comprising one or more software applications, for example. Platform 302 also may comprise storage 318.

In one embodiment, CPU 312 may comprise one or more processors such as dual-core processors. Examples of dual-core processors include the Pentium® D processor and the Pentium® processor Extreme Edition both made by Intel® Corporation, which may be referred to as the Intel Core Duo processors, for example.

In one embodiment, chip set 313 may comprises any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 314 may comprise the Quick Resume Technology Drivers made by Intel® to enable users to instantly turn on and off platform 302 like a television with the touch of a button after initial boot-up, when enabled, for example. In addition, chip set 313 may comprise hardware and/or software support for 5.1 surround sound audio and/or high definition 7.1 surround sound audio, for example. Drivers 314 may include a graphics driver for integrated graphics platforms. In one embodiment, the graphics driver may comprise a peripheral component interconnect (PCI) Express graphics card.

In one embodiment, network connection 315 may comprise the PRO/1000 PM or PRO/100 VD/VM network connection, both made by Intel® Corporation.

In one embodiment, operating system 316 may comprise the Windows® XP Media Center made by Microsoft® Corporation. In one embodiment, one or more media center applications 317 may comprise a media shell to enable users to interact with converged remote control and keyboard device 100 from a distance of about 10-feet away from platform 302 or display device 304, for example. In one embodiment, the media shell may be referred to as a “10-feet user interface,” for example. In addition, one or more media center applications 317 may comprise the Quick Resume Technology made by Intel®, which allows instant on/off functionality and may allow platform 302 to stream content to media adaptors when the platform is turned “off.”

In one embodiment, storage 318 may comprises the Matrix Storage technology made by Intel® to increase the storage performance enhanced protection for valuable digital media when multiple hard drives are included.

In one embodiment, display device 304 may comprises any television type monitor or display. Display device 304 may comprise, for example, a computer display screen, video monitor, television-like device, and/or a television. Display device 304 may be digital and/or analog.

In various embodiments, one or more of devices 306, 308 and 310 may comprise a PC, a DVD player, CD player, DVR, video game, digital video camera, digital still camera, and/or MP3 (MPEG-1 Audio Layer 3 where MPEG stands for Moving Pictures Experts Group) player, among other, for example.

In one embodiment, platform 302 may receive control signals from converged remote control and keyboard device 100.

In various embodiments, system 300 may be implemented as a wireless system, a wired system, or a combination of both. When implemented as a wireless system, system 300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal loads, printed circuit board (PCB), backplane, switch fabric, semiconductor material, twisted-pair wire, co-axial cable, fiber optics, and so forth.

Platform 302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, instant messaging, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

Operations for the above embodiments may be further described with reference to the following figures and accompanying examples. Some of the figured may include a logic flow. Although such figures presented herein may include a particular logic flow, it can be appreciated that the logic flow merely provides an example of how the general functionality as descried herein can be implemented. Further, the given logic flow does not necessarily have to be executed in the order presented unless otherwise indicated. In addition, the give logic flow may be implemented by a hardware element, a software element executed by a processor, or any combination thereof.

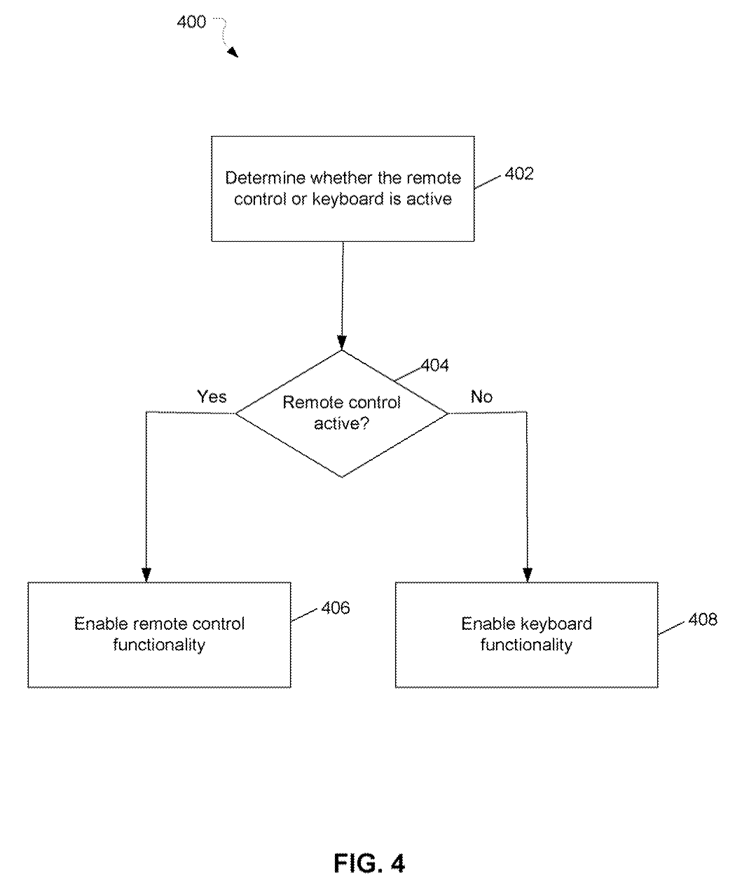

FIG. 4 illustrates one embodiment of a logic flow 400. As shown in logic flow 600, it is determined whether the remote control or the keyboard of converged device 100 is active (block 402). This determination may be based on a control signal. In an embodiment, the remote control is active when the control signal indicates that the lid of converged device 100 is closed. The keyboard is active when the control signal indicates that the lid of converged device 100 is open. In other embodiments, different method of determining which of the remote control and keyboard is active may be incorporated into the present invention. For example, a user may toggle a control button or switch or input a voice command into converged device 100. These example embodiments are not meant to limit the invention.

If the remote control is active (block 404), then the remote control functionality of converged device 100 is enabled (block 406). Otherwise, the keyboard functionality of converged device 100 is enabled (block 408). Embodiments of the invention, however, are not limited to the context shown or described in FIG. 4.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a remote control;
a keyboard; and
a processor to receive a control signal to determine whether to enable functionality of the remote control or functionality of the keyboard.

2. The apparatus of claim 1, wherein the control signal is automatically determined by a position of a lid of the apparatus.

3. The apparatus of claim 2, wherein the remote control functionality is automatically enabled when the lid of the apparatus is closed.

4. The apparatus of claim 2, wherein the keyboard functionality is automatically enabled when the lid of the apparatus is open.

5. The apparatus of claim 1, wherein the keyboard is a micro QWERTY keyboard.

6. A method, comprising:
receiving a control signal, wherein the control signal to determine whether to enable functionality of a remote control or functionality of a keyboard,
wherein the remote control and the keyboard comprise a converged device.

7. The method of claim 6, wherein the control signal is automatically determined by a position of a lid of the converged device.

8. The method of claim 7, wherein the remote control functionality is automatically enabled when the lid of the converted device is closed.

9. The method of claim 7, wherein the keyboard functionality is automatically enabled when the lid of the converged device is open.

10. The method of claim 6, wherein the keyboard is a micro QWERTY keyboard.

11. A machine-readable medium containing instructions which, when executed by a processing system, cause the processing system to perform a method, the method comprising:
receiving a control signal, wherein the control signal to determine whether to enable functionality of a remote control or functionality of a keyboard,
wherein the remote control and the keyboard comprises a converged device.

12. The machine-readable medium of claim 11, wherein the control signal is automatically determined by a position of a lid of the converted device.

13. The machine-readable medium of claim 12, wherein the remote control functionality is automatically enabled when the lid of the converged device is closed.

14. The machine-readable medium of claim 12, wherein the keyboard functionality is automatically enabled when the lid of the converged device is open.

15. The machine-readable medium of claim 11, wherein the keyboard is a micro QWERTY keyboard.
